(19) United States
(12) Patent Application Publication
(10) Pub. No.: US 2023/0048491 A1
(43) Pub. Date: Feb. 16, 2023

(54) COOKING VESSEL AND KITCHEN UTENSIL ASSEMBLY

(71) Applicant: Lumenflon S. P. A., Brandico, Brescia (IT)

(72) Inventor: Vigilio Prandelli, Brandico, Brescia (IT)

(21) Appl. No.: 17/789,414

(22) PCT Filed: Jan. 8, 2021
(86) PCT No.: PCT/IB2021/050109

§ 371 Date: Jun. 27, 2022

(30) Foreign Application Priority Data
Jan. 10, 2020 (IT) 102020000000325

(51) Int. Cl. A47J 45/06; A47J 43/28

(52) U.S. Cl. CPC A47J 45/061; A47J 43/288

(57) ABSTRACT

The invention relates to a cooking vessel and kitchen utensil assembly. The cooking vessel comprises a container suitable to contain food to be cooked and a handle which extends from a side wall of the container; the kitchen utensil comprises a working portion suitable to interact with food, and an elongated gripping portion. The handle of the vessel and the gripping portion are provided with magnetic means suitable to allow the utensil to be locked by magnetic coupling to the handle of the cooking vessel in a substantially overlapping configuration.

The present invention relates to the field of kitchen cooking tools, and in particular it relates to an assembly of a vessel for cooking food and a kitchen utensil suitable to be used together with the vessel. The cooking vessel comprises a container for food to be cooked and a handle which extends from a side portion of said container. The kitchen utensil comprises a working end portion, i.e., suitable to interact with food, and an elongated gripping portion.

Examples of cooking vessels of this type are skillets, grill pans, frying pans, saucepans. Kitchen utensils usable with such vessels are spatulas, carving forks, spoons, ladles, etc., for example.

Cooking vessels having a handle suitable to serve as a rest for the utensil during the cooking operation are already known. Such combinations of vessel handle and utensil indeed serve to solve the problem of the positioning of the utensil during the use thereof or immediately after the preparation of food. Indeed, the utensil, which serves to handle food during cooking, gets dirty and a method for resting it when it is not being handled without soiling the work surface or other objects around the cooking surface is to be found.

Therefore, cooking vessels having a shaped handle to receive the kitchen utensil when it is not handled have been suggested. Since the kitchen utensil is used several times in discontinuous manner during food cooking, the coupling between utensil and handle is to be such as to allow the immediate separation of the utensil from the handle, with a single hand and possibly without moving the cooking vessel. Therefore, at most, the handle has coupling means to be coupled to the utensil, for example side flaps, suitable to prevent the utensil from falling sideways from the handle.

Documents US 2005/0241109, JP 07 36944, US 1 196 543 and JP-A-2005 334583 describe examples of combinations of handle and utensil for a vessel, in which the cooking vessel has a handle suitable to serve as a support for the utensil during cooking. Document GB 761 503 describes a cooking vessel which includes a grill plate supported in a releasable manner with a pivot movement with respect to the edge of the vessel and having a handle opposite to the support point, in which the grill is designed so as to be capable of lying adjacent to the bottom of the vessel and to press the food against such a bottom during cooking. Document US 2 544 846 describes an assembly comprising a movable support or bottom suitable to support food in a lowered position during cooking and to lift the food in the skillet after cooking. The food is thus kept hot and not in contact with the grease in the skillet.

WO2011070601A1 describes a cooking vessel and a kitchen utensil assembly, in which respective mutually complementary coupling portions which allow to lock the utensil to the cooking vessel in a substantially overlapping configuration even when the vessel is hung in vertical position, are obtained in the handle of the vessel and in the gripping portion of the utensil. The coupling portions are shaped so as to obtain a shape coupling, or snap coupling, for example obtained with calibrated interference. Although such an assembly solves the problem of connecting vessel and utensil to each other even when they are not used, in particular when they are put away, for example with the vessel hung on a hook, it is instead less practical and effective during use when the user needs to repeatedly handle the utensil, and therefore he/she needs to separate and then connect the utensil and the handle of the vessel several times again. Indeed, the shape or snap coupling requires given manual dexterity and the application of a given force to couple/separate the two elements, thus in certain cases resulting in an action which interferes with the actual cooking activity and which can end up bothering the cook.

It is the object of the present invention to allow a stable coupling between utensil and cooking vessel, even when they are not used, but which simultaneously overcomes the above-mentioned drawbacks.

Such objects are achieved by an assembly according to claim 1. The dependent claims describe preferred or advantageous embodiments of the assembly.

The features and advantages of the assembly according to the invention will in any case become apparent from the following description of preferred embodiments thereof, given only by way of non-limiting, indicative example, with reference to the accompanying drawings, in which:

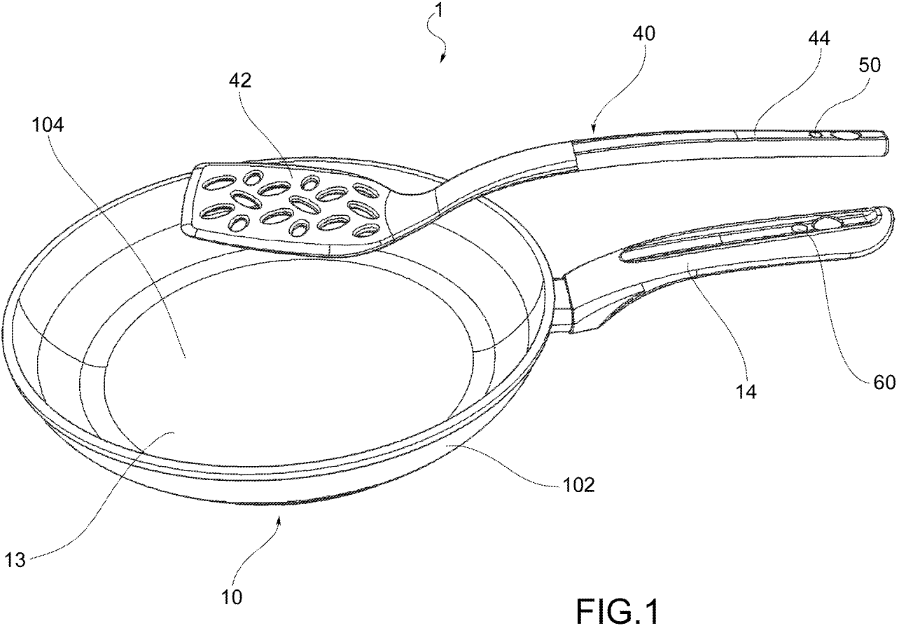

FIG. 1 shows a perspective view of a cooking vessel and a kitchen utensil assembly according to the invention, prior to the coupling thereof;

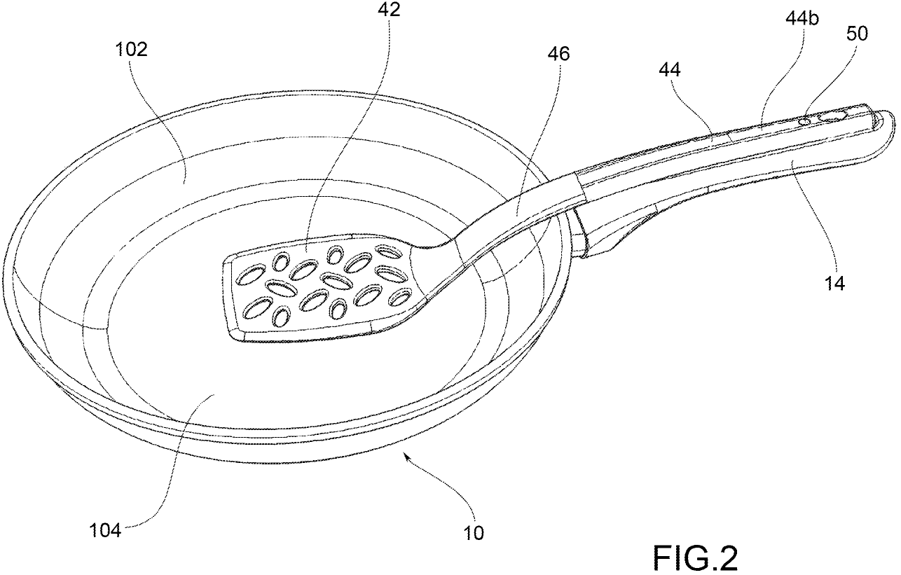

FIG. 2 is a perspective view of the assembly in FIG. 1, with the kitchen utensil coupled to the vessel, in a first coupling mode;

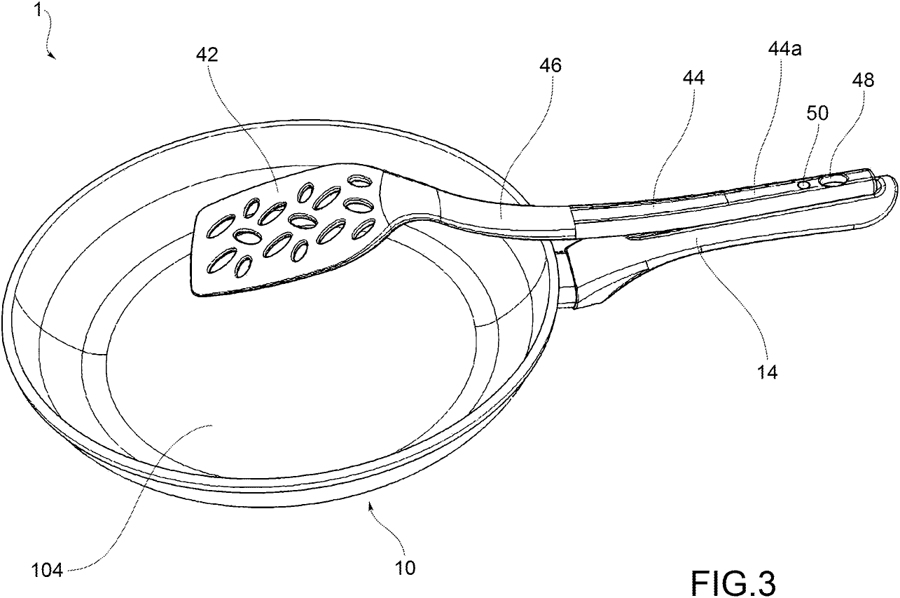

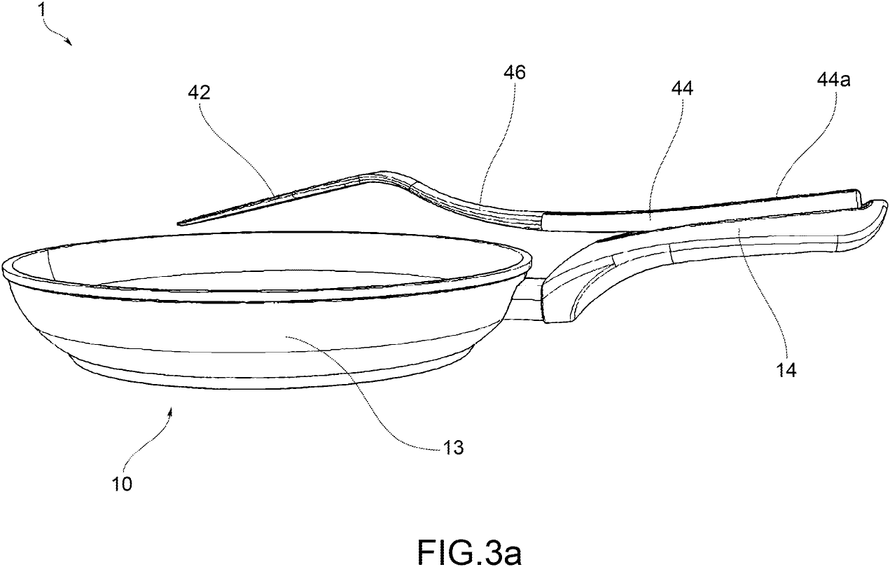

FIGS. 3 and 3a are a perspective and side view, respectively, of the assembly with the kitchen utensil coupled to the vessel, in a second coupling mode;

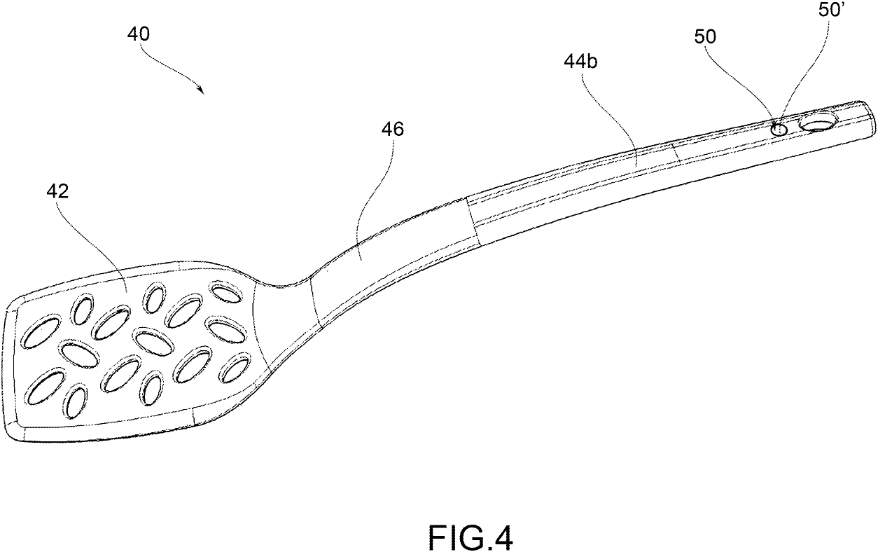

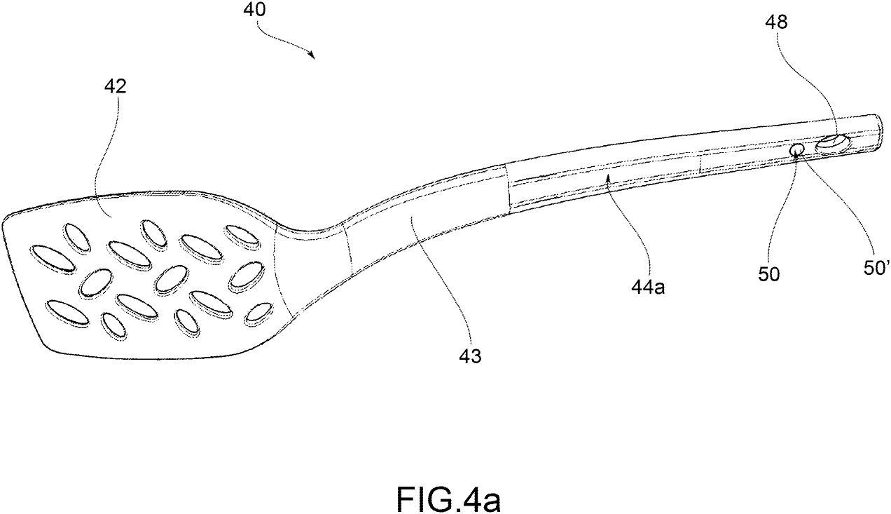

FIGS. 4 and 4a are a top and bottom perspective view, respectively, of the kitchen utensil alone;

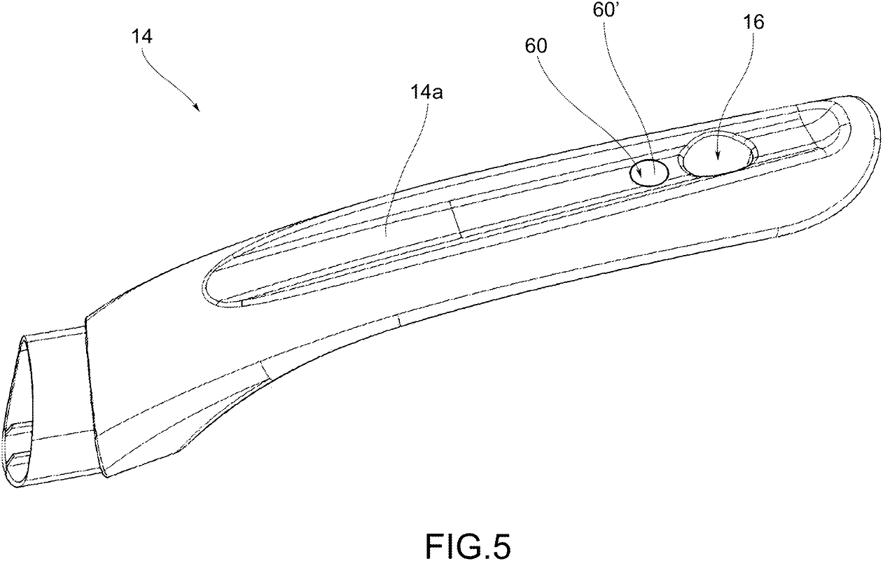

FIG. 5 is a perspective view of the handle of the cooking vessel alone; and

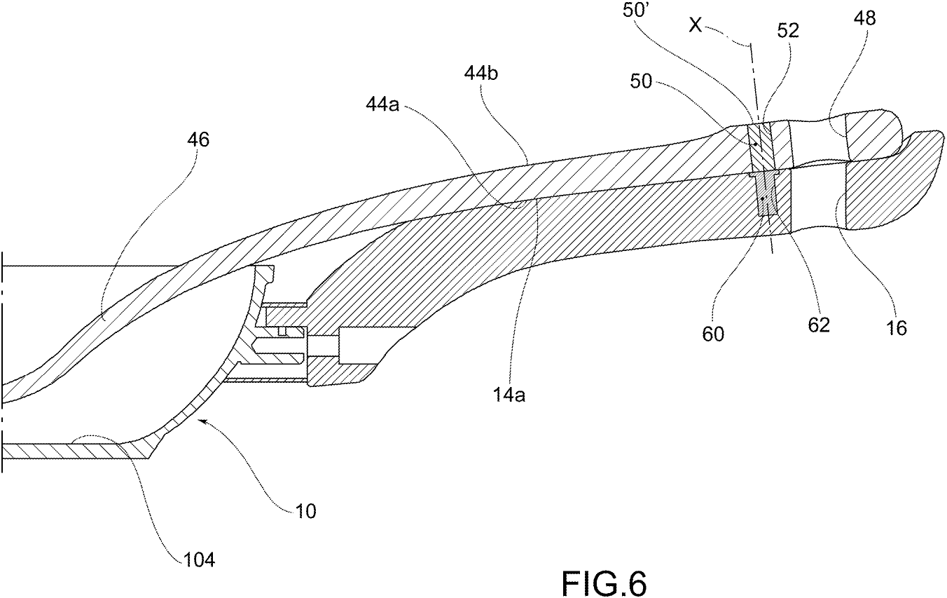

FIG. 6 is a section of a vertical plane of the assembly in FIG. 2.

An assembly of a cooking vessel 10 and a kitchen utensil 40 according to the invention is indicated as a whole in said drawings by numeral 1.

The cooking vessel 10 comprises a container 13 for food to be cooked and a handle 14 which extends from a side wall 102 of said container. For example, the cooking vessel is a skillet, pot, saucepan. Handle 14 can be permanently fastened to container 13 or be of the removable type.

The kitchen utensil 40 can be a spatula, spoon, carving fork, etc.

The kitchen utensil 40 in any case comprises a working portion 42, i.e., suitable to interact with food, for example in the case of a spatula, to remove it from the bottom of the container and turn it over, and an elongated gripping portion 44 having a length which is comparable to that of the handle 14 of vessel 10, for example.

According to an aspect of the invention, the handle 14 of the vessel and the gripping portion 44 are provided with magnetic means suitable to allow utensil 40 to be locked by magnetic coupling to handle 14 of the cooking vessel in a substantially overlapping configuration.

Substantially overlapping configuration means in a relation of at least close approach, with the respective longitudinal axes substantially mutually parallel.

In an embodiment, one of the gripping portion 44 of utensil 40 and the handle 14 of container 10 is provided with a permanent magnet 50; the other one of the gripping portion 44 of utensil 40 and the handle 14 of container 10 is provided with a permanent magnet or a ferromagnetic element 60.

If the gripping portion 44 and handle 14 both have a permanent magnet, the two magnets are polarized so as to mutually attract at least a coupling configuration.

In any case, the magnetic coupling simply requires for the gripping portion 44 and handle 14 to be placed side-by-side. For the uncoupling, it is sufficient to lift the gripping portion 44 with a simple and quick movement, which requires the use of a single hand.

In an embodiment, the gripping portion 44 of utensil 40 is provided with a permanent magnet 50, for example made of Neodymium, and handle 14 is provided with a ferromagnetic element 60, for example made of steel.

Thereby, the uncoupling of the utensil from the handle of the vessel requires less force with respect to the use of two magnets.

In both cases, the force of magnetic attraction can be selected so that receptacle 10 and utensil 40 remain firmly coupled even when the assembly is positioned vertically, for example hung on a hook.

In an embodiment, the permanent magnet 50 has a substantially parallelepiped shape, e.g., cylindrical.

For example, the permanent magnet 50 is a cylinder having height between 10 and 15 mm and a diameter between 4 and 8 mm.

In an embodiment, the ferromagnetic element 60 has a mushroom or nail shape, i.e., it has a head, for example cylinder-shaped, from which a leg having a shorter diameter than the head, extends.

In certain embodiments, the ferromagnetic element 60 could be a plate-like or cylindrical element.

The mushroom-shaped or similar embodiments can facilitate, for example, the locking of the ferromagnetic element 60 in the handle through shape and/or force coupling without using glues or other fastening devices.

Once an upper handle surface 14a for handle 14 and a lower utensil surface 44a and an upper utensil surface 44b for the gripping portion 44 have been defined, in an embodiment, both such lower utensil surface 44a and upper utensil surface 44b are configured to alternatively rest on the upper handle surface 14a. In other words, utensil 40 can rest on handle 14 in two positions rotated from each other by 180°.

To this end, in an embodiment, the ferromagnetic element 60 is accommodated in a respective element seat 62 obtained in the handle so that the upper surface 60' of the ferromagnetic element 60 is substantially coplanar to the upper handle surface 14a.

In an embodiment, the permanent magnet 50 substantially extends for the whole thickness of the gripping portion 44 so that the opposite faces 50' of the permanent magnet 50 are substantially coplanar to the lower utensil surface 44a and to the upper utensil surface 44b, respectively.

In an embodiment, the permanent magnet 50 is accommodated in a respective magnet seat 52 which extends along a magnet axis X substantially orthogonal to the upper handle surface 14a.

For example, the permanent magnet 50 and/or the ferromagnetic element 60 are locked in their respective seats by means of force coupling and/or gluing.

In an embodiment shown in the drawings, the working portion 42 and the gripping portion 44 of the kitchen utensil 40 are not aligned to each other but conventionally, the working portion 42 extends below an imaginary plane in which the lower utensil surface 44a lies. For example, the working portion 42 and the gripping portion 44 are connected to each other by a connection portion 46 which bends downwards with a curvilinear or inclined trend with respect to the direction along which the gripping portion 44 extends.

In a first coupling configuration shown in FIGS. 2 and 6, the kitchen utensil 40 is resting on and magnetically fastened to the handle 14 in the position with the upper utensil surface 44b directed upwards, which corresponds to the position of normal use of the utensil. Here, the working portion 42 adheres to, or in any case is close to, the bottom wall 104 of the container 13. Such a coupling configuration is advantageous because when it is connected to the cooking vessel 10, the kitchen utensil 40 does not significantly limit the volume of the container 13 and thus allows to take advantage of such a volume, for example to accommodate the container of another cooking vessel therein.

In a second coupling configuration shown in FIGS. 3 and 3a, the kitchen utensil 40 is resting on and magnetically fastened to the handle 14 in the position with the lower utensil surface 44a directed upwards, which corresponds to the position rotated by 180° with respect to that of normal use of the utensil. Here, the working portion 42 is furthest spaced apart from the bottom wall 104 of the container 13. Such a coupling configuration is advantageous when container 13 is filled by food to be cooked and therefore there would be no space for the working portion 42 in the first coupling configuration, or when there is a desire for the side of the working portion 42 most in contact with the food to face downwards, therefore towards the bottom wall 104 of the container.

In an embodiment, the handle 14 of the receptacle 10 is provided with a through a hole 16 obtained close to the distal end thereof intended to allow the cooking vessel to be hung. The element seat 62 can be obtained, for example, close to the through hole 16.

In an embodiment, also the gripping portion 44 is provided with a through hole 48 obtained close to the distal end thereof intended to allow the kitchen utensil to be hung. For example, the magnet seat 52 is obtained close to the through hole 48.

In an embodiment, the through holes 16, 48 of the handle and the gripping portion are aligned with each other so as to allow the assembly to be hung on a hook in the coupling configuration between utensil and cooking vessel.

It should be noted that the positioning of the magnet and the ferromagnetic element close to the through holes 16, 48 allows the heating of such magnetic means to be reduced and allows the user to act on the utensil, during the uncoupling from the handle, on the least hot portion of the utensil itself.

Those skilled in the art may make changes and adaptations to the embodiments of the assembly according to the invention or can replace elements with others which are functionally equivalent in order to meet contingent needs without departing from the scope of the following claims.

1. Assembly of a cooking vessel and a kitchen utensil, wherein the cooking vessel comprises a container suitable to contain food to be cooked and a handle which extends from a side wall of the container, and wherein the kitchen utensil comprises a working portion suitable to interact with food and an elongated gripping portion, characterized in that the handle of the vessel and the gripping portion are provided with magnetic means suitable to allow locking, by magnetic coupling, the utensil to the handle of the cooking vessel in a substantially overlapping configuration.

2. Assembly according to claim 1, wherein one of the gripping portion of the utensil and the handle of the container is provided with a permanent magnet, and wherein the other one of the gripping portion of the utensil and the handle of the container is provided with a permanent magnet or a ferromagnetic element.

3. Assembly according to claim 2, wherein the gripping portion of the utensil is provided with a permanent magnet, for example Neodymium, and the handle is provided with a ferromagnetic element, for example a steel element.

4. Assembly according to claim 3, the permanent magnet has a substantially parallelepiped shape, and wherein the ferromagnetic element comprises a cylindrical or plate-like portion.

5. Assembly according to claim 4, wherein the ferromagnetic element has a mushroom or nail shape.

6. Assembly according to claim 4, wherein the handle of the container has an upper handle surface, wherein the gripping portion has a lower utensil surface and an upper utensil surface, both said lower utensil surface and upper utensil surface being suitable to rest, alternatively, on the upper handle surface, wherein the magnetic element is housed in a respective element seat obtained in the handle, and wherein the permanent magnet extends substantially over the entire thickness of the gripping portion so that the opposing faces of the permanent magnet are respectively substantially coplanar to the lower utensil surface and the upper utensil surface.

7. Assembly according to claim 6, wherein the permanent magnet is housed in a respective magnet seat which extends along a magnet axis substantially orthogonal to the upper handle surface.

8. Assembly according to claim 2, wherein the permanent magnet and/or the ferromagnetic element are locked in their respective seats by means of force coupling and/or gluing.

9. Assembly according to claim 5, wherein the handle of the container is provided with a through hole obtained in proximity of its distal end and intended to allow the cooking vessel to be hung, and wherein the element seat is obtained in proximity of the through hole.

10. Assembly according to claim 5, , wherein the gripping portion is provided with a through hole obtained in proximity of its distal end and intended to allow the kitchen utensil to be hung, and wherein the magnet seat is obtained in proximity of the through hole.
